(19) United States
(12) Patent Application Publication
(10) Pub. No.: US 2014/0089618 A1
(43) Pub. Date: Mar. 27, 2014

(54) METHOD AND SYSTEM TO PROVIDE STORAGE UTILIZING A DAEMON MODEL

(71) Applicants: Vishwanath Pattar, Bangalore (IN); Kumarvel Thillai, Bangalore (IN); Adithya Vishwanath, Bangalore (IN)

(72) Inventors: Vishwanath Pattar, Bangalore (IN); Kumarvel Thillai, Bangalore (IN); Adithya Vishwanath, Bangalore (IN)

(73) Assignee: Network Appliance, Inc., Sunnyvale, CA (US)

(21) Appl. No.: 12/483,805

(22) Filed: Jun. 12, 2009

(51) Int. Cl. G06F 12/00; G06F 12/08

(52) U.S. Cl. 711/166; 711/118; 711/E12.001; 707/665

(57) ABSTRACT

A method and system for providing storage using a daemon model. An example system comprises a parent daemon trigger configured to launch a parent storage daemon in response to a storage command from a client, a parent daemon module to perform storage access pre-processing operations to generate initialization data, a storage command detector, a child process trigger module to launch a child process in response to a subsequent storage command, and a child processing module to process subsequent storage commands using the child process.

### TECHNICAL FIELD

The present disclosure pertains to storage systems, and more particularly, to method and system for providing storage utilizing a daemon model.

### BACKGROUND

A storage system is a processing system adapted to store and retrieve data on behalf of one or more client processing systems (“clients”) in response to external input/output (I/O) requests received from clients. A storage system can provide clients with a file-level access to data stored in a set of mass storage devices, such as magnetic or optical storage disks or tapes. Alternatively, a storage system can provide clients with a block-level access to stored data, or with both file-level access and block-level access. Requests from clients directed to a storage system are processed by an application server that may be referred to as a host system (or merely host).

### SUMMARY

In the context of a network environment where clients issue requests to a storage system via a host running a host application, every time a new command is received at the host, the host application performs a predetermined set of pre-processing and post-processing operations associated with the received command. Specifically, for every new command, the host application initializes the storage stack, builds metadata, and performs discovery of the storage destination referenced by the command. These operations may add overhead and repetitive processing, especially where multiple commands are directed to the same storage system. In one example embodiment, the metadata being built by the host application includes information about the associated network attached storage (NAS) device (also referred to as a filer), information related to logical volumes provided by the filer (such as, e.g., mapping information of the volumes), as well as initiator/target information associated with the utilized interconnect technology such as Fibre Channel (FC) or iSCSI (that stands for Internet Small Computer System Interface).

Method and system are presented to provide a host-based storage and snapshot management system that utilizes a daemon model. In multitasking operating systems, a daemon is a computer program that is initiated as a background process and is run in the background, rather than under the direct control of a user. In one example embodiment, the host application may be configured to initiate a daemon for performing various potentially redundant pre-processing and post-processing operations. For example, the daemon may perform initialization of the storage stack and the building of metadata in response to the first storage command and then make this data available for processing of subsequent storage commands from clients. For the purposes of this description, the term “storage command” refers to a command associated with accessing a storage system.

In one embodiment, a subsequent storage command from a client may cause the daemon to spawn a child process that inherits data generated as a result of pre-processing operations performed by the daemon. For the purposes of this description, data generated as a result of operations associated with a storage command may be termed “initialization data.” The subsequent storage command can then be processed by the child storage process. This approach may contribute to enhancing the throughput of the host system and thus provide faster access to the storage system.

### BRIEF DESCRIPTION OF THE DRAWINGS

Embodiments of the present invention are illustrated by way of example and not limitation in the figures of the accompanying drawings, in which like reference numbers indicate similar elements and in which:

FIG. 1 is a diagram of network environment within which an embodiment of the present invention may be implemented;

FIG. 2 is a block diagram illustrating an example host system, according to one example embodiment;

FIG. 3 is a block diagram illustrating various modules provided with a host system, according to one example embodiment;

FIG. 4 is a block diagram illustrating an example daemon model controller, according to one example embodiment;

FIG. 5 is a flow chart of a method for storage provisioning and snapshot management utilizing a daemon model, according to one example embodiment;

FIG. 6 is a flow chart illustrating operations performed by a parent storage daemon and its child process, according to one example embodiment; and

FIG. 7 is a diagrammatic representation of an example machine in the form of a computer system within which a set of instructions, for causing the machine to perform any one or more of the methodologies discussed herein, may be executed.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

In the context of a network environment where client systems are permitted to issue access requests directed to a storage system via a host system (e.g., via an application server configured to process requests from clients to the storage system), every time a new command is issued to a storage provisioning and snapshot management application on the host system (termed a host application), the host application starts with a fresh analysis, metadata generation, storage or snapshot creation and discovery. In some scenarios, for every new storage command received at the host system, the host application performs sanity checks where the host verifies the correctness of syntax, availability of the name supplied, initializes the storage stacks based on a configuration file and the products installed on the system, and also performs data structure, password file, socket, and other initializations. Furthermore, the host application typically builds metadata based on storage components involved, attends to creation/deletion operations on the storage devices, attends to mapping/un-mapping of virtual volume groups on storage devices, as well as performs discovery of logical storage volumes and creates file systems on any logical device that was discovered. Finally, the processing of a storage command from a client concludes by the host application destroying the metadata and de-initializing various data structures and stack.

Method and system are presented to provide a host-based storage and snapshot management system that utilizes a daemon model. In multitasking operating systems, a daemon is a computer program that is initiated as a background process and is run in the background, rather than under the direct control of a user. In one example embodiment, the host system may include a daemon model controller configured to initiate a daemon, termed a parent storage daemon, for performing various storage initialization and other pre-processing operations. The parent storage daemon may be triggered by a first storage command received from a client and perform pre-processing operations with respect to the storage command. A subsequent storage command from a client may cause the parent storage daemon to spawn a child storage process that inherits data generated as a result of pre-processing operations performed by the parent storage daemon. The subsequent storage command can then be processed by the child storage process.

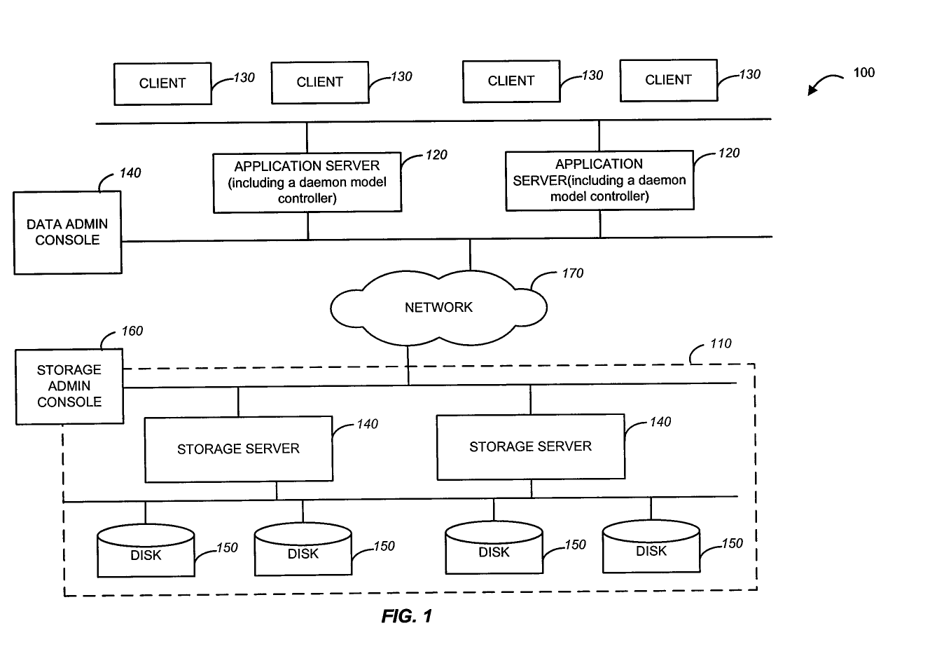

Various operations performed by the parent storage daemon may include building metadata associated with the storage system in response to a first assess request and then updating the previously build metadata to process subsequent storage commands. Utilizing a daemon model for processing storage commands permits, in some scenarios, to parallelize discovery operations, as is described further below, such that the discovery overhead may be reduced to a single discovery delay as opposed to a discovery delay for each independent discovery. Furthermore, where multiple storage commands are directed to the same storage resources, a parent storage daemon may be configured to perform authentication caching, as well as access caching. In one example embodiment, using a daemon model may contribute to enhancing the throughput of host applications. One example embodiment of a system to provide storage and manage snapshots may be implemented in the context of a network environment, as shown in FIG. 1.

FIG. 1 illustrates a network 100 in which embodiments of the invention may be implemented. The network 100 includes a storage system 110 connected to one or more networked application servers 120 serving one or more clients 130. The storage system 110 may be connected to application servers 120 via a network 170. The network 170 may be, for example, a local area network (LAN), wide area network (WAN), metropolitan area network (MAN), the Internet or other network as is known in the art or combinations thereof. The storage system 110 includes one or more networked storage servers 140 connected to one or more networked mass storage devices 150, which may include, for example, magnetic disks, magnetic tape, optical storage devices such as DVDs and/or any other similar media adapted to store data persistently. In one embodiment, mass storage devices 150 are organized as one or more groups Redundant Array of independent (or Inexpensive) Disks (RAID).

The storage server 140 may include one or more processors, a memory, a network adapter, and a storage adapter interconnected by a system bus. The storage server 140, in one example embodiment, executes a storage operating system that, in one embodiment, may be a version of the NetApp® DataONTAP® storage operating system available from NetApp Inc., of Sunnyvale, Calif., that implements a Write Anywhere File Layout (WAFL®) file system. A storage operating system, in one embodiment, virtualizes the storage space provided by storage devices 150 and logically organizes data as a hierarchical structure of named directory and file objects (“directories” and “files”) on the disks.

A network adapter provided with the storage server 140 includes a plurality of ports adapted to couple the storage server 140 to one or more application servers over network 170. The storage adapter provided with the storage server 140 cooperates with the storage operating system to access information requested by application servers 120. A storage adapter may include a plurality of ports having input/output (I/O) interface circuitry that couples to the storage devices 150 over an I/O interconnect arrangement, such as a FibreChannel® link topology, for example. In one embodiment, the storage server 140 may operate in the context of network attached storage (NAS) where the storage server 140 operates as a file server. A file server operates on behalf of one or more application servers 120 to store and manage shared files in storage devices 150. As noted above, storage devices 150 may include one or more arrays of mass storage devices organized as RAID arrays. In one embodiment, the storage server 140 may operate in the context of a storage area network (SAN) context where the storage server 140 provides clients with block-level access to stored data, rather than file-level access. As mentioned above, some storage servers are capable of providing clients with both file-level access and block-level access, such as certain filers made by NetApp Inc. of Sunnyvale, Calif.

In some storage servers, data is stored in logical containers called volumes and aggregates. An “aggregate” is a logical container for a pool of storage resources, combining one or more physical mass storage devices (e.g., disks) or parts thereof into a single logical storage object, which contains or provides storage for one or more other logical data sets at a higher level of abstraction (e.g., volumes). A “volume” is a set of stored data associated with a collection of mass storage devices, such as disks, which obtains its storage from (i.e., is contained within) an aggregate, and which is managed as an independent administrative unit. A volume includes one or more file systems which may be active file systems (i.e., subject to dynamic read and write operations) and, optionally, one or more persistent point-in-time images (“snapshots”) of the active file systems captured at various instances in time. A “file system” is an independently managed, self-contained, hierarchal set of data units. A volume or file system may store data in the form of files or in the form other units of data, such as blocks or logical units (LUNs).

Returning to FIG. 1, application servers 120 are computers that handle requests for data, electronic mail, file transfers and other network services from client systems 130. Application servers 120 utilize the services of storage system 110 to store and manage data in the mass storage devices 150. Application servers 120 may communicate with storage system 110 by using file-based access protocols, such as the Common Internet File System (CIFS) protocol or Network File System (NFS) protocol, over the Transmission Control Protocol/Internet Protocol (TCP/IP) when accessing information in the form of files and directories. Alternatively, application servers 120 may communicate with storage system 110 using block-based access protocols, such as the Small Computer Systems Interface (SCSI) protocol encapsulated over TCP (iSCSI) and SCSI encapsulated over FibreChannel® Protocol (FCP), when accessing information in the form of data blocks. The storage system 110 may be connected to a storage administrator's console 140, which may be used by a storage administrator to create data management policies to provision storage space on mass storage devices 150. Similarly, application servers 120 may be connected to a data administrator's console 160, which may be used by a data administrator to create data management profiles for data sets associated with each of application servers 120.

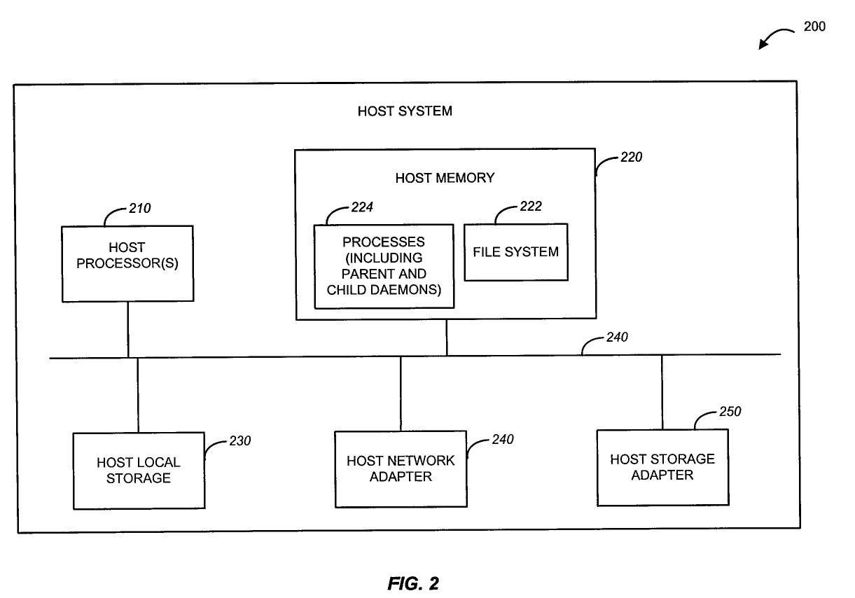

The application server 120 is a computer system that may be configured to handle requests for data, electronic mail, file transfers, and other network services from other computers, e.g., the clients 130. The application server 120 may execute Microsoft™ Exchange Server and Microsoft™ SQL Server, both products provided by Microsoft Corp., of Redmond, Wash. Microsoft Exchange Server is a messaging and collaboration software system that provides support for electronic mail (e-mail) to various clients (such as the clients 130) connected to the associated host system. The application server 120 may be configured to receive requests from the clients 130, directed at the storage system 110. The application server 120, in one embodiment, may utilize a daemon model for processing such requests. A daemon model may be embodied in a module termed a daemon model controller. Various functions performed by an example daemon model controller are described further below. An example application server 120, acting as a host system with respect to the clients 130 and the storage system 110, may be described with reference to FIG. 2.

Referring now to FIG. 2, a host system 200 comprises host processor(s) 210, a host memory 220, a host network adapter 240, a host storage adapter 250, and a local storage 230 coupled by a bus 214. The host processors 210 are the central processing units (CPUs) of the host system 110 and, thus, control the overall operation of the host system 110. In certain embodiments, the host processors 210 accomplish this by executing software, such as that described in more detail herein. The host processors 210 may include one or more programmable general-purpose or special-purpose microprocessors, digital signal processors (DSPs), programmable controllers, application specific integrated circuits (ASICs), programmable logic devices (PLDs), or the like, or a combination of such devices.

The host memory 220 comprises storage locations that are addressable by the host processors 210 and adapters (a host network adapter 240 and a host storage adapter 250) for storing running processes 340 and a file system 224 associated with the present invention. The host processors 210 and adapters may, in turn, comprise processing elements and/or logic circuitry configured to execute the software code and manipulate various data structures. Host memory 220 can be a random access memory (RAM), a read-only memory (ROM), or the like, or a combination of such devices. It will be apparent to those skilled in the art that other processing and memory means, including various computer readable media, may be used for storing and executing program instructions pertaining to the invention described herein.

The host network adapter 240 comprises a plurality of ports adapted to couple the host system 110 to one or more clients 140 (shown in FIG. 1) over point-to-point links, wide area networks, virtual private networks implemented over a public network (Internet) or a shared local area network. The host network adapter 240 thus may comprise the mechanical, electrical and signalling circuitry needed to connect the node to the network.

The host storage adapter 250 cooperates with the host operating system executing on the host system 110 to access data from disks 150 (shown in FIG. 1). The host storage adapter 250 comprises a plurality of ports having input/output (I/O) interface circuitry that couples to the disks 150 over an I/O interconnect arrangement, such as a conventional high-performance, fibre channel (FC) link topology.

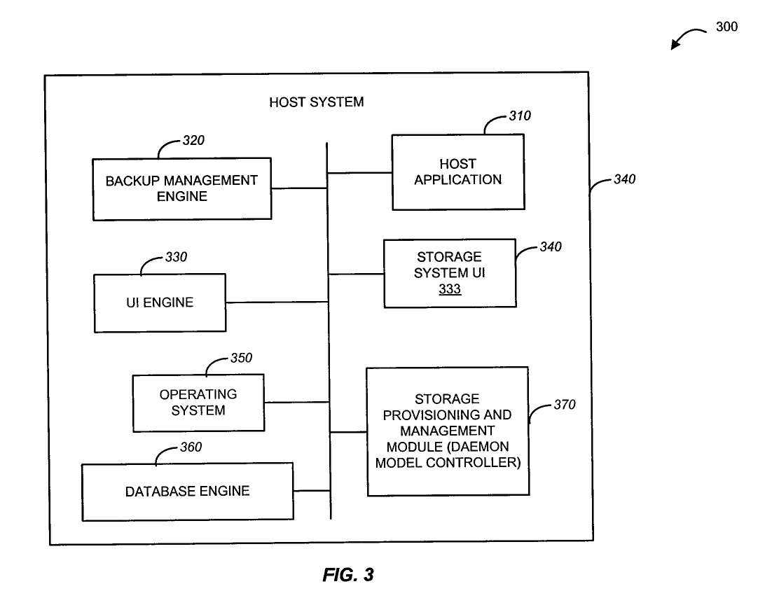

The host local storage 230 is a device that stores information within the host system 200, such as software applications, host operating system, and data. The host system 200 loads the software applications and host operating system into the host memory 220 as running processes 340. The processes 340, in one example embodiment, include a parent storage daemon responsible for performing various operations aimed at reducing redundancy in processing storage commands (such as, e.g., initialization operations and operations for building metadata associated with storage access requests from clients), as well as child storage processes spawned from the parent storage daemon. An example host system 300 that may correspond to the system 200 of FIG. 2, representing functional modules that may be implemented in software, hardware, or a combination thereof, may be described with reference to FIG. 3.

Referring now to FIG. 3, according to embodiments of the present invention, the system 300 may be configured to execute the following software applications: a host application(s) 310, a backup management engine 320, a user interface engine 330, a storage system interface engine 340, a host operating system 350, and a database engine 360. The host application 220 can be, for example, a database server, although embodiments of the present invention contemplate that other host applications can be executed at host system 300. In one embodiment, electronic messages are received from clients 140 shown in FIG. 1 by the database server and are passed to the database engine 360. The database engine 360, in turn, may store the received messages on disks 150 of FIG. 1 as files. As used herein, the term “file” encompasses a container, an object, or any other storage entity.

The backup management engine 320 may be configured to cause the storage system 110 of FIG. 1 to back up storage groups using, for example, snapshot capability. The backup management engine 320 also causes the storage system 110 to create snapinfo files that are stored on disk(s) 150. A snapinfo file may include information about a particular snapshot. This information may be, for example, a time stamp indicating when a particular snapshot was taken and the location where the snapshot is stored on disk(s) 150. A backup dataset includes one or more snapshots of application data. A backup dataset may further include a transaction log of changes to the application data and one or more snapinfo files describing a backup dataset.

After the backup management engine 320 initiates creation of snapshots by sending a command to the storage system 120 via the storage system interface engine 340, the storage operating system 350 creates snapshots and snapinfo files. The storage operating system 350 may report back to the backup management engine 320 when the operation is completed. The storage system interface engine 340 may be configured to act as an interface between the host system 110 and the storage system 120. The storage system interface engine 340 communicates with storage system 120 using, for example, Zephyr Application and Programming Interface (ZAPI) protocol. In one implementation, the storage system interface engine 340 is a SnapDrive® for Windows, a product provided by NetApp Inc., of Sunnyvale, Calif.

The host operating system 350, in one example embodiment, is a program that is, after being initially loaded into the host memory, manages host applications executed on the host system 300. The host operating system 350 may be, for example, UNIX®, Windows NT®, Linux®, or any other general-purpose operating system.

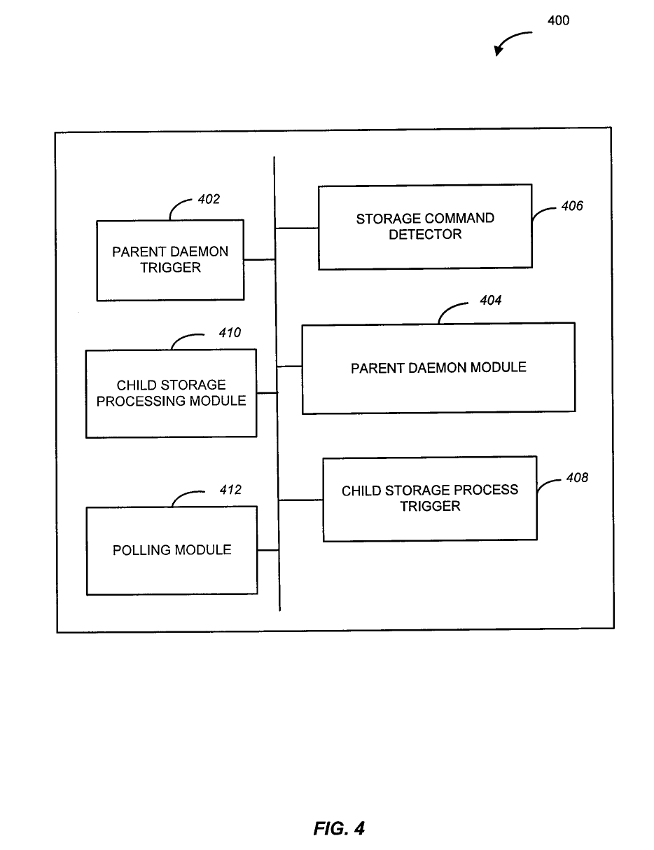

Also shown in FIG. 3 is a daemon model controller 370. The daemon model controller, in one example embodiment, is configured to utilize a daemon model to facilitate performance improvement of host-based storage provisioning and snapshot management. An example daemon model controller 400 may be discussed with reference to FIG. 4.

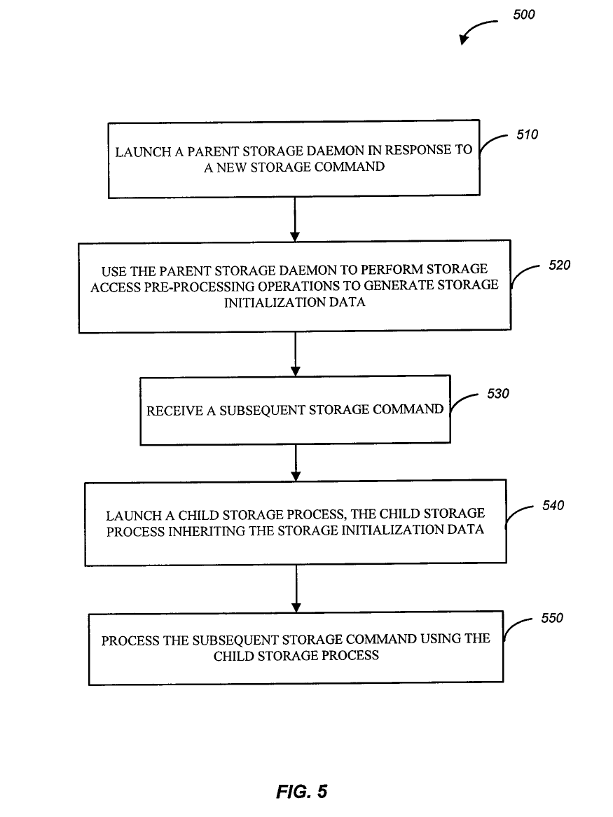

As shown in FIG. 4, the daemon model controller 400 includes a parent daemon trigger 402, a parent daemon module 404, a storage command detector, a child storage process trigger module 408, and a child storage processing module 410. The parent daemon trigger 402 may be configured to launch a parent storage daemon in response to the storage command detector 406 receiving a new storage command. A storage command may be a command from a client directed to a storage system (e.g., a storage access command from the client 130 of FIG. 1 to the storage system 110 of FIG. 1). A storage command may be, e.g., a command line interface (CLI) command or an application programming interface (API) call. The parent daemon module 404 may be configured to perform storage access pre-processing operations to generate storage initialization data, using the parent storage daemon. Some pre-processing operations may include initializing the storage stack, building metadata, performing authentication operations, etc. The child storage process trigger 408 may be configured to launch a child storage process. As mentioned above, the child storage process inherits the storage initialization data generated by the parent daemon. The child storage processing module 410 may be configured to process subsequent storage commands using the child storage process. The system 400 may further comprise a polling module 412 to poll for further storage access commands on a port specified in a configuration file. Example operations performed by a daemon model controller may be discussed with reference to FIG. 5.

FIG. 5 is a flow chart of a method 500 for storage provisioning and snapshot management, according to one example embodiment. The method 500 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the host system 300 shown in FIG. 3.

As shown in FIG. 5, the method 500 commences at operation 510, where the parent daemon trigger 402 of FIG. 4 launches a parent storage daemon in response to a new storage command. The parent daemon module 404 of FIG. 4 performs storage access pre-processing operations to generate storage initialization data, using the parent storage daemon, at operation 520. At operation 530, the storage command detector 406 of FIG. 4 receives a subsequent storage command, which causes the child storage process trigger 408 of FIG. 4 to launch a child storage process at operation 540. The child storage process inherits the storage initialization data generated by the parent storage process daemon. At operation 550, the child storage processing module 410 of FIG. 4 processes the subsequent storage command using the child storage process.

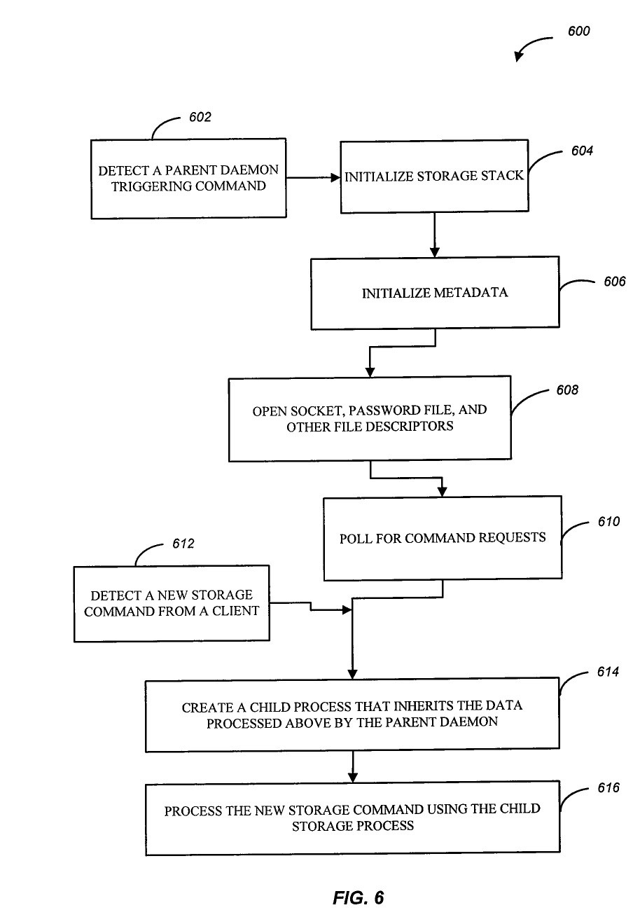

FIG. 6 is a flow chart illustrating one example configuration (a method 600) of a parent storage daemon that may be provided, e.g., with Snapdrive® for UNIX. Snapdrive® is a registered trademark of NetApp Inc., of Sunnyvale, Calif. The method 600 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the host system 300 shown in FIG. 3.

As shown in FIG. 6, the method 600 commences at operation 602, where a parent storage daemon is started at the host system. The parent storage daemon initializes the storage stack based on the configuration file at operation 604 and keeps the initialization database updated. After initialization of the storage stack, the parent storage daemon uses that knowledge to detect out the volume manager, file system and other details related to the associated storage system and to build metadata at operation 606. At operation 608, the parent storage daemon opens various files such as the daemon password file, the authentication file, etc. The associated file descriptors are stored in the memory of the host system. Also at operation 608, the parent storage daemon opens the socket descriptors and commences listening on the port specified through the configuration file, at operation 610.

For any new storage command requests from a client received on the port specified through the configuration file (operation 612), the parent storage daemon spawns a child process that inherits the initialized data and metadata, at operation 614. The child process that inherits initialization data from the parent storage daemon need not perform initialization operations again. The child process can simply update the existing metadata. The child process can handle CLI commands, as well as APIs received on the port associated with the parent storage daemon. The new command is processed by the child process at operation 616.

As described above, when a new command is issued to the host application, the child is spawned from the parent storage daemon that will processes the new command request. When a daemon model is utilized by a host application, the discovery operations associated with the storage system may be optimized, particularly in case of parallel commands. An example of an optimized discovery process may be described as follows. A child storage process associated with the parent storage daemon may request the parent to discover the LUN for the child process. If the discovery has not yet been commenced, the parent daemon may start the discovery operation with respect to the requested LUN. If the discovery has already been commenced, the parent daemon may queue the discovery request and wait until the discovery is completed. If the LUN discovery request was queued in a previous cycle or if the LUN is visible after the previous discovery, the LUN is declared as discovered. If, however, the LUN discovery request has not been queued in a previous cycle or if the LUN is not visible as a result of a previous discovery, a fresh discovery is performed by the parent storage daemon and the status of the LUN is updated.

A host application configured to use the daemon model described herein may benefit from configuring the parent daemon to store cached information in memory and use it for processing subsequent requests. The parent daemon can be configured to bypass various role-based access control (RBAC) operations, authentication operations, and SCSI scan operations by caching previously obtained data. Daemon caching according to one embodiment may be discussed using an example of RBAC caching. When a RBAC command is issued for a child process, the child process contacts its parent daemon for data, the parent daemon checks if there is an entry for a user associated with the RBAC command, and allows access if the timestamp associated with the request is within a predetermined threshold. If the timestamp associated with the request indicates that the cached authentication for the user has expired, the parent daemon sends an authentication request for the user to the data fabric manager (DFM), obtains the authentication status, caches it in memory and selectively allows/disallows the requested operation based on the obtained authentication status. In one example embodiment, centralizing caching interface through a parent daemon may contribute to limiting or eliminating cache coherency issues and the need for cache updating by a child process.

In one example embodiment, a daemon model may provide an infrastructure for polling for storage requests from clients and accepting the requests of the APIs. For example, APIs may be decoded into a common format to which CLI commands are decoded and are processed in the manner the equivalent CLI commands are processed. This approach may contribute to saving development effort and avoiding code duplication in order to improve maintainability, consistency, etc.

Some potential advantages that may be associated with some embodiments described herein may be described as follows. One time initialization may save considerable time and may make storage provisioning faster. Consolidation of the discovery operations may help avoid repetitive discovery and may improve the speed of command execution. Caching may help avoid delays due to communication with the storage system for every command.

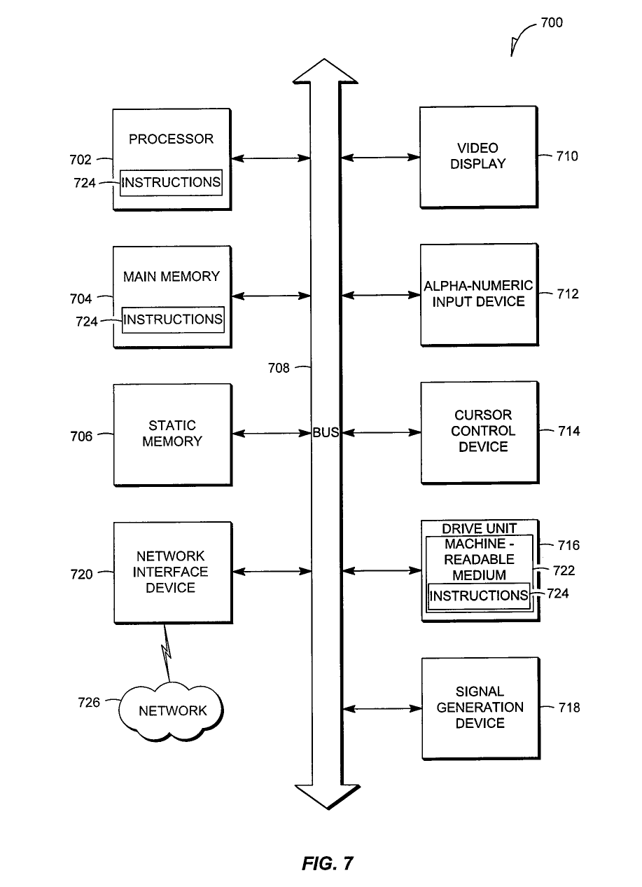

FIG. 7 shows a diagrammatic representation of a machine in the example form of a computer system 700 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU) or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an alpha-numeric input device 712 (e.g., a keyboard), a user interface (UI) navigation device 714 (e.g., a cursor control device), a disk drive unit 716, a signal generation device 718 (e.g., a speaker) and a network interface device 720.

The disk drive unit 716 includes a machine-readable medium 722 on which is stored one or more sets of instructions and data structures (e.g., software 724) embodying or utilized by any one or more of the methodologies or functions described herein. The software 724 may also reside, completely or at least partially, within the main memory 704 and/or within the processor 702 during execution thereof by the computer system 700, with the main memory 704 and the processor 702 also constituting machine-readable media.

The software 724 may further be transmitted or received over a network 726 via the network interface device 720 utilizing any one of a number of well-known transfer protocols (e.g., Hyper Text Transfer Protocol (HTTP)).

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like.

Thus, method and system for providing storage utilizing a daemon model have been described. The techniques described herein may be adapted for use in other systems that include customizable and/or complex installation configurations. The embodiments described herein may be implemented in an operating environment comprising software installed on a computer, in hardware, or in a combination of software and hardware. Although embodiments have been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the embodiment(s). In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the embodiment(s).

1. A computer-implemented system comprising:
a parent daemon trigger to launch a parent storage daemon in response to a new storage command, the new storage command directed to a storage system;
a parent daemon module to perform storage access pre-processing operations to generate initialization data, using the parent storage daemon, the storage access pre-processing operations including initializing the storage stack, building metadata, and performing authentication operations;
a storage command detector to receive a subsequent storage command;
a child process trigger to launch a child process, the child process inheriting the initialization data responsive to the receiving of the subsequent storage command, the initialization data generated as a result of the pre-processing operations performed by the parent daemon; and
a child processing module to process the subsequent storage command using the child process.

2. The system of claim 1, wherein the parent daemon module is to initialize a storage stack associated with the storage system.

3. The system of claim 2, wherein the parent daemon module is to build metadata associated with the storage system using the initialized storage stack.

4. The system of claim 1, wherein the parent daemon module is to perform authentication operations.

5. The system of claim 1, further comprising a polling module to poll for further storage access commands.

6. The system of claim 5, wherein the storage command detector is to cooperate with the polling module to receive the subsequent storage command.

7. The system of claim 5, wherein the polling module is to poll on a port specified in a configuration file.

8. The system of claim 1, wherein the parent storage daemon module is to receive a request from the child storage, the request being to discover a target volume associated with the storage system.

9. The system of claim 1, wherein the parent storage daemon module is to cache the initialization data for future use.

10. The system of claim 1, wherein the subsequent storage command is an application programming interface (API).

11. A computer-implemented method comprising:
using one or more processors to perform operations of:
launching a parent storage daemon in response to a new storage command, the new storage command directed to a storage system;
using the parent storage daemon to perform storage access pre-processing operations to generate initialization data, the storage access pre-processing operations including initializing the storage stack, building metadata, and performing authentication operations;
receiving a subsequent storage command;
responsive to the receiving of the subsequent storage command, launching a child process, the child process inheriting the initialization data, the initialization data generated as a result of the pre-processing operations performed by the parent daemon; and
processing the subsequent storage command using the child process.

12. The method of claim 11, wherein the storage pre-processing operations include initializing a storage stack associated with the storage system.

13. The method of claim 12, wherein the storage pre-processing operations include building metadata associated with the storage system using the initialized storage stack.

14. The method of claim 11, wherein the storage pre-processing operations include performing authentication operations.

15. The method of claim 11, further comprising polling for further storage access commands.

16. The method of claim 15, wherein the receiving of the subsequent storage command is responsive to the polling for further storage access commands.

17. The method of claim 15, wherein the polling for further storage access commands is associated with a port specified in a configuration file.

18. The method of claim 11, further comprising detecting a request from the child process to the parent storage daemon, the request being to discover a target volume associated with the storage system.

19. The method of claim 11, further comprising caching the initialization data for future use.

20. A computer system comprising:
a processor for executing instructions in the form of computer code;
a memory device in communication with the processor, the memory device for storing instructions executable by the processor;
computer code to launch a parent storage daemon to process a new storage command from a client system, the new storage command requesting access to a storage system;
computer code to generate initialization data using a parent storage daemon, the initialization data including storage stack initialization data;
computer code to cache the initialization data;
computer code to receive a subsequent storage command directed to the storage system;
computer code to launch a child process responsive to the receiving of the subsequent storage command, the child process inheriting the initialization data; and
computer code to process the subsequent storage command using the child process.
